(19) United States
(12) Patent Application Publication
(10) Pub. No.: US 2018/0182224 A1
(43) Pub. Date: Jun. 28, 2018

(54) ON-BOARD CHARGER WITH EXHAUST DETECTION

(71) Applicant: SHENZHEN GULI SCIENCE & TECHNOLOGY CO., LTD., Shenzhen (CN)

(72) Inventor: Hongyong YU, Shenzhen (CN)

(73) Assignee: SHENZHEN GULI SCIENCE & TECHNOLOGY CO., LTD., Shenzhen (CN)

(21) Appl. No.: 15/736,112

(22) PCT Filed: Jun. 22, 2016
(86) PCT No.: PCT/CN2016/086731

§ 371 Date: Dec. 13, 2017

(30) Foreign Application Priority Data
Sep. 23, 2015 (CN) 201520743322.5

(51) Int. Cl. G08B 21/14; H01R 24/58; H02J 7/00; H01R 24/62

(52) U.S. Cl. CPC G08B 21/14; H01R 24/58; H02J 7/0042; H02J 7/0052; H01R 2103/00; H01R 24/62; H02J 2007/0059; H02J 2007/0037; H02J 2007/004; H02J 7/0029

(57) ABSTRACT

An on-board charger with exhaust detection integrates a safety hammer function and an exhaust detection function, realizing a safer automobile life. The on-board charger has a shell. Two on-board charger cathode elastic piece are provided on the shell. The bottom end of the shell is an on-board charger anode. After the shell is inserted into a cigarette lighter socket, the on-board charger cathode elastic pieces and the on-board charger anode are connected with an automobile power supply circuit. The on-board charger anode has an inverted cone structure. The bottom end of the on-board charger anode is the top end of a cone. A ventilation window in communication with the interior of the shell is provided at a position close to the top of the shell. The interior of the shell is provided with a gas sensor for detecting automobile exhaust content. The gas sensor is connected to an alerter. The interior of the shell is provided with a DC-DC voltage transformation circuit.

### CROSS REFERENCE OF RELATED APPLICATION

The present application claims the priority of the Chinese patent application CN2015207433225 filed on Sep. 23, 2015, which is incorporated herein in its entirety.

### FIELD OF THE UTILITY MODEL

The present utility model relates to an on-board charger, and particularly to a multifunctional on-board charger.

### BACKGROUND OF THE UTILITY MODEL

The family car possessing quantity is growing, and portable digital products such as mobile phones are also becoming more and more popular. Usually, the cigarette lighter socket is a standard feature in a car, and can serve as a power source for the cigarette lighter or other devices. The cigarette lighter socket is connected with the power supply circuit inside the car, and generally provides direct current. An on-board charger plugged in the cigarette lighter socket only has a charging function via a USB port, and does not integrate other functions. If other functions need to be realized for the on-board charger, more related products need to be bought separately and will occupy more space.

In addition, we are also paying attention to the design of self-saving devices inside a car. In case of emergency, it is necessary to quickly break the car window. Usually, if people fall asleep in a car in an indoor parking lot or an outdoor parking environment with slight wind, exhaust gas poisoning may occur. The existing on-board charger does not have an on-board safety assistance function and a self-saving function in emergency.

### SUMMARY OF THE UTILITY MODEL

The present utility model intends to solve the above shortcomings in the prior art by providing an on-board charger with exhaust detection. The on-board charger integrates the functions of a safety hammer and exhaust detection, thereby realizing a safer automobile life.

To solve the above technical problems, the on-board charger with exhaust detection disclosed by the present utility model adopts the following technical solutions.

An on-board charger with exhaust detection and to be plugged in an on-board cigarette lighter socket comprises a shell, wherein two on-board charger cathode elastic pieces are provided on the shell; the bottom end of the shell is an on-board charger anode; after the shell is inserted into the cigarette lighter socket, the on-board charger cathode elastic pieces and the on-board charger anode are connected with an automobile power supply circuit; the on-board charger anode has an inverted cone structure; the bottom end of the on-board charger anode is the top end of a cone; a ventilation window in communication with the interior of the shell is provided at a position close to the top of the shell; the interior of the shell is provided with a gas sensor for detecting automobile exhaust content; the gas sensor is connected to an alerter;

the interior of the shell is provided with a DC-DC voltage transformation circuit; the DC-DC voltage transformation circuit realizes power supply via the cigarette lighter socket by electrically connecting with the on-board charger cathode elastic pieces and the on-board charger anode; and the DC-DC voltage transformation circuit supplies power to a USB charge interface provided on the top end of the shell.

Preferable embodiments and further improvements of the present utility model are as below.

Further, the gas sensor is a CO gas sensor; the interior of the shell is provided with an independent gas chamber in communication with the exterior of the shell via the ventilation window; the CO gas sensor is arranged inside the gas chamber; the alerter is an acoustic-optical alerter having a speaker, the speaker being close to a speaker hole provided in the shell; and power supply to the alerter and the gas sensor is realized via the cigarette lighter socket after the DC-DC voltage transformation circuit is electrically connected with the on-board charger cathode elastic pieces and the on-board charger anode.

Further, the DC-DC voltage transformation circuit is further connected with a charge-discharge protection circuit for preventing excessive charging, excessive discharging and short circuits.

Further, an on-board charger anode-cathode insulating layer is arranged on the shell and between the on-board charger anode and the on-board charger cathode elastic pieces.

Further, the on-board charger anode is made of stainless steel.

Further, anti-slip grains are uniformly distributed on the outer surface close to the top end of the shell; the anti-slip grains are grooves and/or projections; and an LED indication lamp is arranged at the top end of the shell.

Further, the shell is made of metal.

The advantageous effects of the present utility model are as below.

In the on-board charger with exhaust detection disclosed by the present utility model, as the on-board charger anode has an inverted cone structure, and the bottom end of the on-board charger anode is the top end of a cone, a sharp corner is formed at the end of the on-board charger anode. The sharp corner can break the automobile window in emergency, thereby facilitating rescue.

In the present utility model, as a ventilation window in communication with the interior of the shell is provided at a position close to the top of the shell, the interior of the shell is provided with a gas sensor for detecting automobile exhaust content, and the gas sensor is connected to an alerter, the present utility model has an exhaust detection function, which can detect invasion of exhaust for people in the automobile, and particularly for sleeping people in the automobile.

In the present utility model, as the DC-DC voltage transformation circuit supplies power to a USB charge interface provided on the top end of the shell, the power can be converted into direct current of various specifications for other electric devices. Therefore, the present utility model is very convenient.

### BRIEF DESCRIPTION OF THE DRAWINGS

FIG. 1 is a schematic front view of an embodiment of the present utility model;

FIG. 2 is a schematic rear view of an embodiment of the present utility model;

FIG. 3 is a schematic internal structural view of an embodiment of the present utility model; and

FIG. 4 is a schematic top view of an embodiment of the present utility model.

### DESCRIPTION OF THE REFERENCE SIGNS

1—shell; 2—ventilation window; 3—on-board charger cathode elastic piece; 4—on-board charger anode-cathode insulating layer; 5—on-board charger anode; 6—speaker hole; 7—alerter; 8—DC-DC voltage transformation circuit; 9—LED indication lamp; 10—USB charging interface; 11—anti-slip grains.

### DETAILED DESCRIPTION OF THE EMBODIMENTS

The followings will describe the specific embodiments of the present utility model with reference to the drawings.

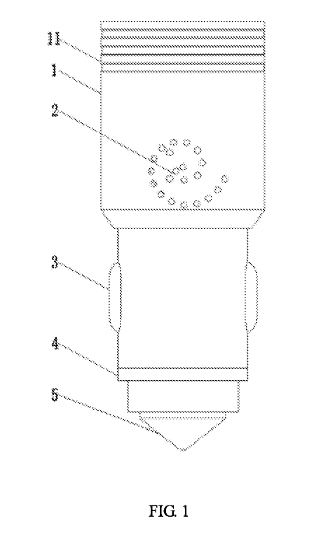

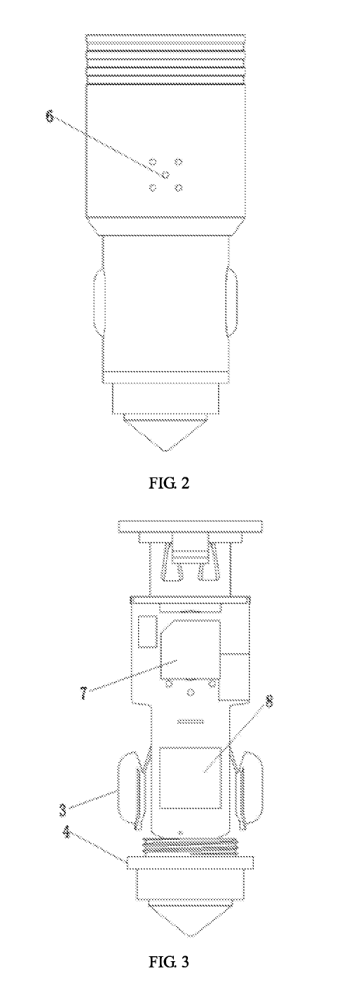

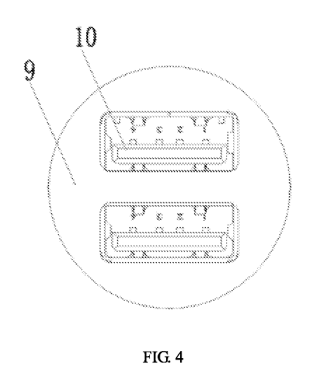

As shown in FIGS. 1-4, specific embodiments of the present utility model are shown.

As shown in these figures, an on-board charger with exhaust detection and to be plugged in an on-board cigarette lighter socket comprises a shell 1, wherein two on-board charger cathode elastic pieces 3 are provided on the shell 1; the bottom end of the shell is an on-board charger anode 5; after the shell is inserted into the cigarette lighter socket, the on-board charger cathode elastic pieces and the on-board charger anode are connected with an automobile power supply circuit; the on-board charger anode has an inverted cone structure; the bottom end of the on-board charger anode is the top end of a cone; a ventilation window 2 in communication with the interior of the shell is provided at a position close to the top of the shell; the interior of the shell is provided with a gas sensor for detecting automobile exhaust content; the gas sensor is connected to an alerter 7.

The interior of the shell is provided with a DC-DC voltage transformation circuit 8; the DC-DC voltage transformation circuit realizes power supply via the cigarette lighter socket by electrically connecting with the on-board charger cathode elastic pieces 3 and the on-board charger anode 5; and the DC-DC voltage transformation circuit supplies power to a USB charge interface provided on the top end of the shell.

The present utility model can integrate a safety hammer function, a charging function and an exhaust detection function in a position and volume of an on-board charger. The safety hammer is realized by the sharp corner structure at the bottom, which will be made from stainless steel (but not limited to stainless steel) to ensure the rigidity.

The automobile exhaust detection function of the present utility model is realized mainly by the gas sensor. Detection and acoustic and optical alert issuing are realize by circuits. Therefore, casualties due to introduction of exhaust in the automobile when people are sleeping inside the automobile with the windows closed can be avoided. When the vehicle is idling, the CO content in the exhaust is over 120 times higher than the normal content and seriously exceeds the acceptable safe level for a human body. Therefore, when the vehicle is idling in an independent garage or the outdoor wind speed is too low, if people sleep inside the vehicle with the air-conditioner running and the windows closed, the fatality rate is very high. In addition, people are unconscious when poisoned by CO.

The charging function of the present utility model is realized by the DC-DC voltage transformation circuit, which efficiently integrates short circuit prevention, excessive current prevention, and excessive voltage prevention functions. Further, the power supply efficiency is high.

Preferably, as shown in the figures, the gas sensor is a CO gas sensor; the interior of the shell is provided with an independent gas chamber in communication with the exterior of the shell via the ventilation window; the CO gas sensor is arranged inside the gas chamber; the alerter is an acoustic-optical alerter having a speaker, the speaker being close to a speaker hole 6 provided in the shell; and power supply to the alerter and the gas sensor is realized via the cigarette lighter socket after the DC-DC voltage transformation circuit is electrically connected with the on-board charger cathode elastic pieces and the on-board charger anode. The independent gas chamber can measure the hazardous substance content in the gas more accurately. In addition, the speaker is used to wake up the people inside the vehicle.

Preferably, the DC-DC voltage transformation circuit is further connected with a charge-discharge protection circuit for preventing excessive charging, excessive discharging and short circuits.

Preferably, as shown in the figures, an on-board charger anode-cathode insulating layer is arranged on the shell and between the on-board charger anode and the on-board charger cathode elastic pieces. After providing the insulating layer, the insulation between the cathode and the anode will be more reliable.

Preferably, the on-board charger anode is made of stainless steel, which can facilitate breaking of vehicle windows.

Preferably, as shown in the figures, anti-slip grains 11 are uniformly distributed on the outer surface close to the top end of the shell; the anti-slip grains are grooves and/or projections; and an LED indication lamp 9 is arranged at the top end of the shell. The anti-slip grains can help gripping of the shell.

Preferably, the shell is made of metal.

The above has described the preferred embodiments of the present utility model in detail with reference to the drawings. But the present utility model is not limited to the above embodiments. Various modifications, which are made to the present utility model within the knowledge known by those skilled in the art and without departing from the spirit of the present utility model, relate to the technologies known by those skilled in the art and shall fall into the protection scope of the present utility model.

Many other changes and variations can be made within the concept and the scope of the present utility model. It should be understood that the present utility model is not limited to specific embodiments, and the scope of the present utility model is defined by the attached claims.

1-7. (canceled)

8. An on-board charger with exhaust detection and to be plugged in an on-board cigarette lighter socket, comprising:
a shell, wherein two on-board charger cathode elastic pieces are provided on the shell; the bottom end of the shell is an on-board charger anode; after the shell is inserted into the cigarette lighter socket, the on-board charger cathode elastic pieces and the on-board charger anode are connected with an automobile power supply circuit, wherein
the on-board charger anode has an inverted cone structure; the bottom end of the on-board charger anode is the top end of a cone; a ventilation window in communication with the interior of the shell is provided at a position close to the top of the shell; the interior of the shell is provided with a gas sensor for detecting automobile exhaust content; the gas sensor is connected to an alerter;
the interior of the shell is provided with a DC-DC voltage transformation circuit; the DC-DC voltage transformation circuit realizes power supply via the cigarette lighter socket by electrically connecting with the on-board charger cathode elastic pieces and the on-board charger anode; and the DC-DC voltage transformation circuit supplies power to a USB charge interface provided on the top end of the shell.

9. The on-board charger with exhaust detection according to claim 8, wherein the gas sensor is a CO gas sensor; the interior of the shell is provided with an independent gas chamber in communication with the exterior of the shell via the ventilation window; the CO gas sensor is arranged inside the gas chamber; the alerter is an acoustic-optical alerter having a speaker, the speaker being close to a speaker hole provided in the shell; and power supply to the alerter and the gas sensor is realized via the cigarette lighter socket after the DC-DC voltage transformation circuit is electrically connected with the on-board charger cathode elastic pieces and the on-board charger anode.

10. The on-board charger with exhaust detection according to claim 8, wherein the DC-DC voltage transformation circuit is further connected with a charge-discharge protection circuit for preventing excessive charging, excessive discharging and short circuits.

11. The on-board charger with exhaust detection according to claim 8, wherein an on-board charger anode-cathode insulating layer is arranged on the shell and between the on-board charger anode and the on-board charger cathode elastic pieces.

12. The on-board charger with exhaust detection according to claim 8, wherein the on-board charger anode is made of stainless steel.

13. The on-board charger with exhaust detection according to claim 8, wherein anti-slip grains are uniformly distributed on the outer surface close to the top end of the shell; the anti-slip grains are grooves and/or projections; and an LED indication lamp is arranged at the top end of the shell.

14. The on-board charger with exhaust detection according to claim 8, wherein the shell is made of metal.
